(19) United States
(12) Patent Application Publication
(10) Pub. No.: US 2020/0142954 A1
(43) Pub. Date: May 7, 2020

(54) Document Production by Conversion from Wireframe to Darwin Information Typing Architecture (DITA)

(71) Applicant: Netgear, Inc., San Jose, CA (US)

(72) Inventors: Devaang Mandalia, Los Angeles, CA (US); Lisa Pampuch, Morgan Hill, CA (US)

(73) Assignee: Netgear, Inc.

(21) Appl. No.: 16/178,004

(22) Filed: Nov. 1, 2018

(51) Int. Cl. G06F 17/22; G06F 17/27

(52) U.S. Cl. CPC G06F 17/2264; G06F 17/2765

(57) ABSTRACT

The present invention improves document production by automating a conversion of wireframe files highly useable for engineering and design to a Darwin Information Typing Architecture (DITA) file highly useable for producing documents. The DITA file can be generated by extracting text from a wireframe file, which can typically be formatted as a Portable Document Format (PDF) document, to a text file, identifying instances of one or more keywords in the text file and associating such instances with steps for a DITA task. Multiple wireframe files can be converted to provide multiple DITA tasks in a single DITA file. In one aspect, steps can be identified in a text file by iteratively analyzing the file for keywords in one or more loops and tagging instances of the keywords with related chunks of text.

### BACKGROUND OF THE INVENTION

### 1. Field of the Invention

The present invention relates to technical document production, and more particularly, to a computer generating a Darwin Information Typing Architecture (DITA) file for technical document production by extracting text from a wireframe file to a text file, identifying an instance of a keyword in the text file and associating the instance with a step for a DITA task.

### 2. Discussion of the Related Art

The Darwin Information Typing Architecture (DITA) is a known open standard Extensible Markup Language (XML) data model for authoring and publishing documents. DITA files are created by dividing information into specialized “topic” types. Topic types currently include “task,” “concept,” “reference,” “glossary” and “troubleshooting” types. Each of these topic types is a specialization of a generic topic type which can contain a title element, a prolog element for metadata and a body element. The body element can contain paragraph, table and list elements, similar to Hypertext Markup Language (HTML).

While DITA files are useful for creating different types of documents from a common set of content, such as user manuals, knowledge-based articles, tech support chats, web pages and the like, it is sometimes difficult to transform the originating content into a DITA file. This is particularly problematic where the content is derived from files that are intended for engineering and design applications, such as “wireframes,” which are schematics or blueprints containing text and/or graphics implementing a design. Generating a DITA file from such content typically requires extensive manual effort to examine the engineering or design work in order to capture DITA tasks. What is needed is an improved system for generating DITA files from files that are intended for engineering and design applications while minimizing such effort and maintaining accuracy.

### SUMMARY OF THE INVENTION

The present invention improves document production by automating a conversion of wireframe files highly useable for engineering and design to a Darwin Information Typing Architecture (DITA) file highly useable for producing documents. The DITA file can be generated by extracting text from a wireframe file, which can typically be formatted as a Portable Document Format (PDF) document, to a text file, identifying instances of one or more keywords in the text file and associating such instances with steps for a DITA task. Multiple wireframe files can be converted to provide multiple DITA tasks in a single DITA file. In one aspect, steps can be identified in a text file by iteratively analyzing the file for keywords in one or more loops and tagging instances of the keywords with related chunks of text. The DITA file, in turn, can be used to produce an array of documents, such as user manuals, knowledge-based articles, tech support chats, web pages and the like.

In one aspect, the conversion can be accomplished by executing a conversion program to extract text from a wireframe PDF and create a corresponding DITA file. Wireframes are typically produced for the design of a user interface or user experience when a new product or feature is being created. DITA is typically used by technical writers to organize content which can be used for creation of documents. The program can be written, for example, in Python, an interpreted high-level programming language for general-purpose programming, such as by using Python packages including “PyPDF2” and “lxml” and/or Python classes including “Element” and “ElementTree.” In one aspect, the conversion program can be structured as follows: (1) loads the PDF file into a Python object and extract text from the object; (2) format the text by removing unnecessary new line characters; (3) dividing the text into multiple parts, such as text that belongs to screens and text that provides description of the file itself; (4) further divided the description, for example, into short description and pre-requisites sections using keywords “Overview” and “Requirements” contained in the text; (5) further divided text from all the screens, for example, per each screen using the keyword “Notes:” and some conditional statements; (6) create tags of the DITA file, such as by using the Python “Element” class to; (7) create more tags dynamically based on the number of screens in the wireframe; (8) assigning text has been broken down into meaningful chunks to corresponding tag, with a DITA file being ready at the end of this step; (9) create indentations in the DITA file to make it readable, such as by using an indent class to logically indent each tag within the DITA file; and (10) providing a new file created in a folder, which could be a same folder as the conversion program and/or the wireframe passed to the conversion program. The DITA file that is generated, which can be further edited as desired, can be used for creation of user content.

In addition, identification of DITA tags can be dynamically updated based on changes to requirements and/or protocol. More keywords within a wireframe file can be used to help categorize the information further, such as titles, headers, results and the like. Also, the conversion program can pull a wireframe file from a particular Uniform Resource Locator (URL) or web address, create a DITA file and upload the DITA file back to the destination URL or web address.

Accordingly, unlike conversions from PowerPoint, XML or HTML, which are highly structured and therefore easier to process, the present invention allows conversion from wireframe PDFs despite their forming unstructured text. Wireframe PDFs are more useful in that they are more typically used for engineering and design applications. The present invention brings structure to the extracted text through the conversion program to make a DITA file useable for producing documents. As a result, the present invention advantageously streamlines a conversion process from wireframe PDFs to user related documentation.

Specifically then, one aspect of the present invention provides a method for document production, including: a computer extracting text from a wireframe file to a text file, the wireframe file including multiple graphic sets, each graphic set including a graphic associated with text, the graphic sets being arranged in a predetermined order for instructing a given activity, the text file including a string of characters including text of the graphic sets, wherein characters of each graphic set are ordered consistently with corresponding characters in the text file; the computer identifying an instance of a keyword in the text file; and the computer generating a DITA file by associating the instance of the keyword with a step for a DITA task.

Another aspect of the invention can provide a method for document production, including: a computer extracting text from a wireframe file to a text file, the wireframe file including a group of text including a plurality of sections, each section containing text in a stylized font, each section being arranged in a predetermined order for instructing a given activity, the text file including a string of characters including text of the group, wherein characters of each section are ordered consistently with corresponding characters in the text file; the computer identifying an instance of a keyword in the text file; and the computer generating a DITA file by associating the instance of the keyword with a step for a DITA task.

Another aspect of the invention can provide a system for document production, the system including a processor executing a program stored in a non-transient medium to: extracting text from a wireframe file to a text file, the wireframe file including a group of text divided in multiple sections and multiple graphic sets, each section containing text in a stylized font, each graphic set including a graphic associated with text, the group of text and the graphic sets being arranged in a predetermined order for instructing a given activity, the text file including a string of characters including text of the group of text and the graphic sets, wherein characters of each section and characters of each graphic set are ordered consistently with corresponding characters in the text file; identify multiple instances for each of multiple keywords in the text file; and generate a DITA file by associating each instance of the keyword with a step for a DITA task.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a block diagram of an electronic system for document production in accordance with an aspect of the invention;

FIG. 2 is a flow chart for executing document production in the system of FIG. 1;

FIG. 3 is a flow diagram illustrating file handling in the system of FIG. 1; and

FIGS. 4A and 4B illustrate different parts of an exemplar wireframe file which could be used in the system of FIG. 1 in accordance with an aspect of the invention.

### DETAILED DESCRIPTION OF THE PREFERRED EMBODIMENTS

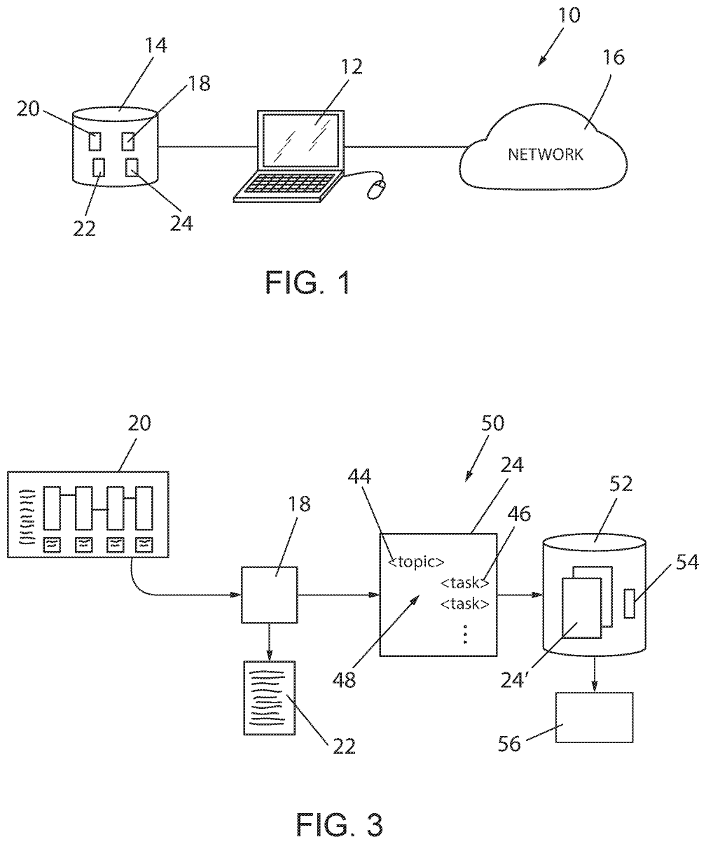

Referring now to FIG. 1, an electronic system 10 for document production is provided in accordance with an aspect of the invention. The system 10 can include a computer 12 in communication with a non-transient data structure 14 and a computer network 16. A processor of the computer 12 can execute a program 18 to automate conversion of one or more wireframe files that are highly useable for engineering and design applications to one or more DITA files that are highly useable for producing documents, such as user manuals, knowledge-based articles, tech support chats, web pages and the like. Wireframe files are electronic files providing schematics or blueprints containing text and/or graphics implementing a process or design. Wireframe files can be used by engineering and design teams, for example, to design web pages, screens for applications executing in smartphones or tablets, and the like. In one aspect, a wireframe file can be single page PDF document.

In particular, by way of example, the computer 12 can execute the program 18 to automate conversion of a wireframe file 20 to a DITA file 24. The computer 12 can automate the conversion by extracting text from the wireframe file 20, into a text file 22, and by executing an operation with the text file 22 to generate the DITA file 24, as described herein. The computer 12 can retrieve the wireframe file 20 from another source, such as an engineering or design server to be used by an engineering or product development team, through the network 16. The computer 12 can also distribute the DITA file 24 to another location, such as a document production server to be used by a document production team, through the network 16. The network 16 could comprise a Local Area Network (LAN) and/or a Wide Area Network (WAN). Also, although the data structure 14 is illustrated as a separate structure, the data structure 14 could be integrated with the computer 12.

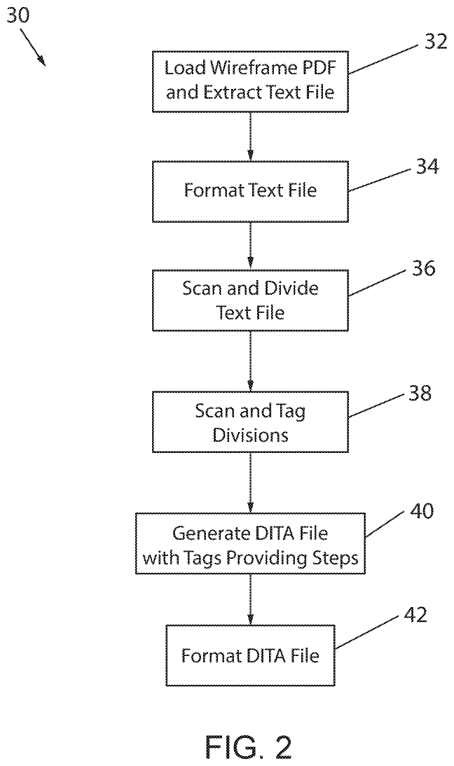

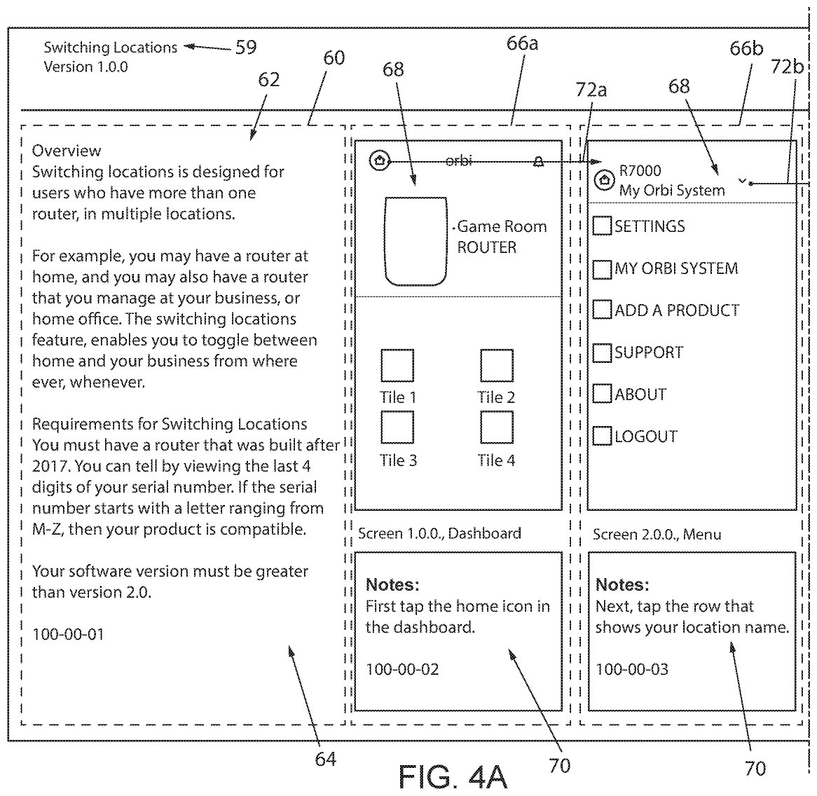

Referring now to FIG. 2, illustrating a flow chart 30 for executing document production in the system of FIG. 1, and with additional reference to FIG. 3, illustrating a flow diagram 50 with related file handling, generation of the DITA file 24 for document production is provided in accordance with an aspect of the invention. At step 32, the computer 12 could execute the program 18 to load the wireframe file 20 and extract text from the wireframe file 20 into the text file 22. In one aspect, the program can load the wireframe file 20 into a Python object to extract text from the object. The wireframe file 20, which could be a PDF document, can include a group of text divided in multiple sections and multiple graphic sets providing a schematic or blueprint implementing a process or design. Each section can contain text in a stylized font, and each graphic set can include a graphic associated with text. The group of text and the graphic sets can be arranged in a predetermined order for instructing a given activity. The text file 22 can include a string of characters including text of the group of text and the graphic sets. Characters of each section and characters of each graphic set are preferably ordered consistently with corresponding characters in the text file.

At step 34, the computer 12 can optionally format the text file 22 to better prepare the file before further operation. Formatting the text file could include, for example, removing extraneous characters in the text file 22 that are unnecessary to the DITA file 24, such as newline characters.

Next, steps can be identified in the text file 22 by iteratively analyzing the text file for keywords in one or more loops and tagging instances of the keywords. In one aspect, at step 36, the computer 12 can scan the text file 22 for one or more first-tier keywords and divide the text file 22 based on the first-tier keywords into multiple parts or divisions. For example, the computer 12 can scan the text file 22 for the keyword “Overview” to divide the text that provides description of the file itself from the text that belongs to screens. Then, at step 38, the computer 12 can further scan the multiple parts or divisions of the text file 22 for one or more second-tier keywords and tag instances of each second-tier keyword in the text file 22 with related chunks of text. For example, the computer 12 can further scan the division of the text that provides the description of the file itself for the keywords “Overview” and “Requirements” to separate chunks of text corresponding to short description and pre-requisites sections, respectively. The computer 12 can also scan the division of the text that belongs to the screens for the keyword “Notes:” to separate chunks of text corresponding to each screen. The computer 12 can iteratively analyze the text file 22 and tag instances of keywords by executing a conversion program prepared in Python, using Python packages including “PyPDF2” and “lxml,” and/or Python classes, including “Element” and “ElementTree.”

At step 40, the computer 12 can generate the DITA file 24 by associating each instance of the keyword, tagged in the text file 22, with a step for a DITA task. This essentially allows assigning text, which has been broken down into meaningful chunks to corresponding tags, to steps of the DITA task. The DITA file 24 is ready at the end of this step as a new file created in a folder, which could be a same folder as the program 18 and/or the wireframe file 20. The DITA file 24 will have a DITA “task” topic 44 corresponding to a given activity or objective as instructed by the wireframe file 20, and multiple DITA “steps” 46 below the task topic, corresponding to the process or design as set forth in the wireframe file 20 for accomplishing the given activity.

Finally, at step 42, the computer 12 can optionally format the DITA file 24 to better prepare the file for document production. Formatting the DITA file 24 could include, for example, adding an indentation 48 before each step arranged below the DITA task. The DITA file 24 can then be stored with other DITA files 24, locally in the data structure 14, and/or at another location, such as a document production server 52 used by a document production team, through the network 16. In addition, the DITA file 24 can be stored with a DITA map 54, for producing various documents 56, such as user manuals, knowledge-based articles, tech support chats, web pages and the like. The DITA map 54 can provide a container for topics, giving the topics sequence and structure, to enable transformation of the collection of content into a publication.

Accordingly, the DITA file 24 can be generated by extracting text from the wireframe file 20 into a text file 22, identifying instances of one or more keywords in the text file 22 and associating such instances with steps 46 for a DITA task 44 in the DITA file 24. In another aspect, multiple wireframe files 22 can be converted to provide multiple DITA tasks 44 in a single DITA file 24. The DITA file 24, in turn, can be used to produce the aforementioned array of documents 56.

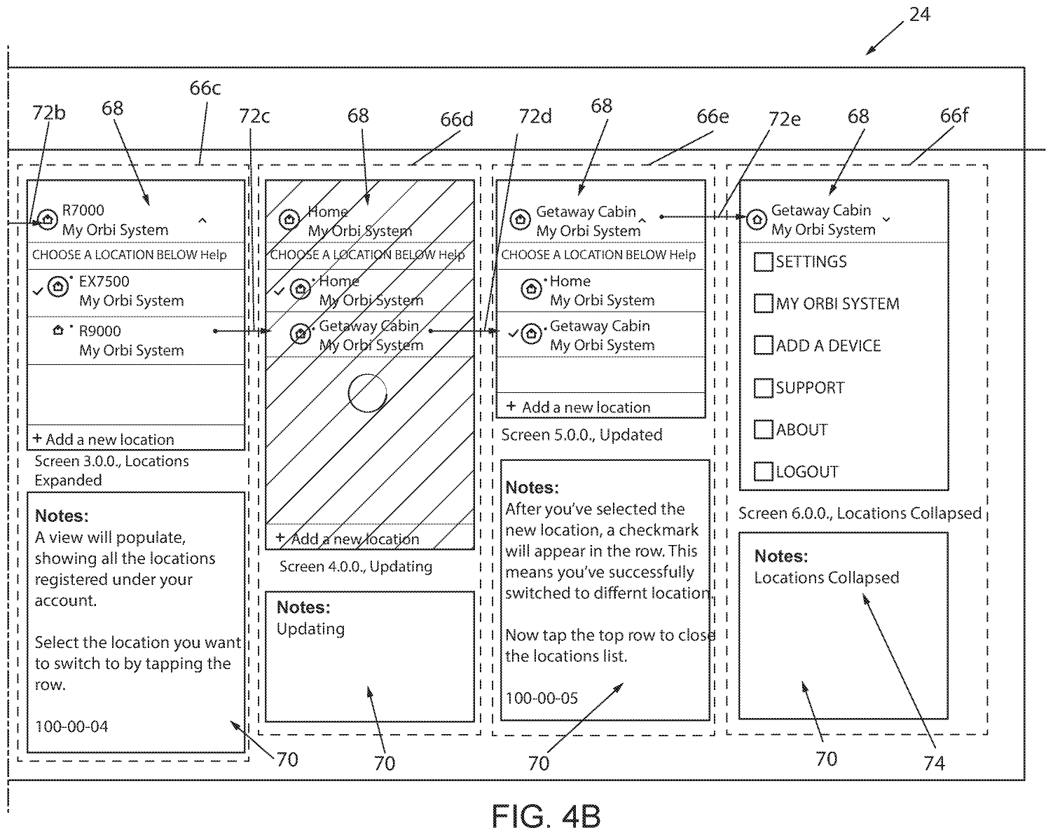

Referring now to FIGS. 4A and 4B, an exemplar wireframe file 20 which could be used in the system of FIG. 1 is illustrated in accordance with an aspect of the invention. The wireframe file 20 could be formatted as a single page PDF document. In the example shown, the wireframe file 20 is schematic or blueprint for implementing screens for an application executing on smartphone or tablet for switching router locations (“Switching Locations”). Beginning at FIG. 4A, the wireframe file 20 can include a group of text 60, which provides a description of the file itself, divided in multiple sections, such as first and second sections 62 and 64, respectively. The first and second sections 62 and 64, respectively, each contain text in a stylized font to maximize user experience. The first section 62 contains text with the keyword “Overview” followed by text corresponding to short description about switching router locations. The second section 64 contains text with the keyword “Requirements” followed by text corresponding to pre-requisites for conducting the activity.

In addition, the wireframe file 20 can include multiple graphic sets 66a, 66b, 66c, and so forth, providing screens with notes for conducting the activity, in this case, switching router locations. Each graphic set 66 can include a graphic 68 associated with text 70. For example, a graphic 68 of the first graphic set 66a can include an image of a screenshot for a smartphone depicting a dashboard with icons including a home button and a router. Text 70 associated with the graphic 68 of the first graphic set 66a can indicate “Notes:” which instruct to “First tap the home icon in the dashboard.” A link 72a from the home button of the first graphic set 66a to the second graphic set 66b illustrates the continuing design flow to the second graphic set 66b. Then, a graphic 68 of the second graphic set 66b can include an image of a screenshot for the smartphone depicting a drop-down list from the home button. Text 70 associated with the graphic 68 of the second graphic set 66b can indicate “Notes:” which instruct to “Next, tap the row that shows your location name.” With additional reference to FIG. 4B, a link 72b from the second graphic set 66b to the third graphic set 66c illustrates the continuing design flow to the third graphic set 66c. The graphic sets 66 can proceed in this order for instructing the activity, e.g., switching router locations.

The group of text 60 and the graphic sets 66 can be arranged in a predetermined order for instructing the given activity. For example, the group of text 60 can be arranged before the graphic sets 66. In addition, in the group of text 60, the “Overview” section can be arranged before the “Requirements” section. Also, with respect to the graphic sets 66, the first graphic set 66a, which provides “Notes:” instructing to “First tap the home icon in the dashboard” can be arranged before the second graphic set 66b, which provides “Notes:” instructing to “Next, tap the row that shows your location name.”

To generate the DITA file 24, the computer 12 can execute to load the wireframe file 20 and extract text from the wireframe file 20 into the text file 22. This can include all text of the wireframe file 20, from the title 59 (“Switching Locations”) to the last text 74 of the last graphic set 66 (“Locations Collapsed”). Characters from each of the group of text 60 and the graphic sets 66 are preferably ordered consistently with corresponding characters in the text file 22. For example, where the first section 62 contains the text “Overview” followed by “Switching locations is designed for users who have more than one router, in multiple locations . . . ,” characters in the text file can consistently contain “Overview \n Switching locations is designed for users who have more than one router, in multiple locations. \n” and so forth, with “\n” denoting a newline. The computer 12 can optionally format the text file 22, for example, by removing such newline characters. Then, the computer 12 can identify a DITA task 44 corresponding to the title 59 (“switching locations”), along with steps for the DITA task 44 corresponding to chunks of text from the group of text 60 and the graphic sets 66, by iteratively analyzing the text file 22 for keywords in one or more loops, tagging instances of the keywords, and preparing the DITA file 24, including with formatting and storage, as described above with respect to FIGS. 2 and 3.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

It should be appreciated that such a development effort might be complex and time consuming, but would nevertheless be a routine undertaking of design, fabrication, and manufacture for those of ordinary skill having the benefit of this disclosure. Nothing in this application is considered critical or essential to the present invention unless explicitly indicated as being “critical” or “essential.”

What is claimed is:

1. A method for document production, comprising:
a computer extracting text from a wireframe file to a text file, the wireframe file comprising a plurality of graphic sets, each graphic set comprising a graphic associated with text, the graphic sets being arranged in a predetermined order for instructing a given activity, the text file comprising a string of characters including text of the graphic sets, wherein characters of each graphic set are ordered consistently with corresponding characters in the text file;
the computer identifying an instance of a keyword in the text file; and
the computer generating a Darwin Information Typing Architecture (DITA) file by associating the instance of the keyword with a step for a DITA task.

2. The method of claim 1, wherein the wireframe file further comprises a group of text preceding the graphic sets, and wherein the string of characters of the text file further includes text from the group of text.

3. The method of claim 1, wherein the graphic comprises an image of screenshot.

4. The method of claim 1, wherein the keyword is a first keyword, and further comprising the computer identifying instances of a plurality of keywords in the text file and generating the DITA file by associating each instance of the plurality of keywords with a step for the DITA task.

5. The method of claim 1, wherein the wireframe file, the text file and the DITA task are a first wireframe file, a first text file and a first DITA task, respectively, and further comprising the computer extracting text from a second wireframe file to a second text file, identifying a plurality of instances of the keyword in the second text file, and associating each instance of the keyword with a step for a second DITA task in the DITA file.

6. The method of claim 1, wherein the wireframe file is a single page Portable Document Format (PDF) document.

7. The method of claim 1, further comprising the computer formatting the text file before identifying the plurality of instances, wherein formatting the text file comprises removing a plurality of characters from the text file.

8. The method of claim 1, further comprising the computer formatting the DITA file by adding an indentation to the step arranged below the DITA task.

9. A method for document production, comprising:
a computer extracting text from a wireframe file to a text file, the wireframe file comprising a group of text comprising a plurality of sections, each section containing text in a stylized font, each section being arranged in a predetermined order for instructing a given activity, the text file comprising a string of characters including text of the group, wherein characters of each section are ordered consistently with corresponding characters in the text file;
the computer identifying an instance of a keyword in the text file; and
the computer generating a DITA file by associating the instance of the keyword with a step for a DITA task.

10. The method of claim 9, wherein the wireframe file further comprises a plurality of graphic sets, each graphic set comprising a graphic associated with text, the graphic sets being arranged in the predetermined order for instructing the given activity, and wherein the string of characters of the text file further includes text of the graphic sets.

11. The method of claim 10, wherein the graphic comprises an image of screenshot.

12. The method of claim 9, wherein the keyword is a first keyword, and further comprising the computer identifying instances of a plurality of keywords in the text file and generating the DITA file by associating each instance of a plurality of keywords with a step for the DITA task.

13. The method of claim 9, wherein the wireframe file, the text file and the DITA task are a first wireframe file, a first text file and a first DITA task, respectively, and further comprising the computer extracting text from a second wireframe file to a second text file, identifying a plurality of instances of the keyword in the second text file, and associating each instance of the keyword with a step for a second DITA task in the DITA file.

14. The method of claim 9, wherein the wireframe file is a single page PDF document.

15. The method of claim 9, further comprising the computer formatting the text file before identifying the plurality of instances, wherein formatting the text file comprises removing a plurality of characters from the text file.

16. The method of claim 9, further comprising the computer formatting the DITA file by adding an indentation to the step arranged below the DITA task.

17. A system for document production, the system comprising a processor executing a program stored in a non-transient medium to:
extracting text from a wireframe file to a text file, the wireframe file comprising a group of text divided in a plurality of sections and a plurality of graphic sets, each section containing text in a stylized font, each graphic set comprising a graphic associated with text, the group of text and the graphic sets being arranged in a predetermined order for instructing a given activity, the text file comprising a string of characters including text of the group of text and the graphic sets, wherein characters of each section and characters of each graphic set are ordered consistently with corresponding characters in the text file;
identify a plurality of instances for each of a plurality keywords in the text file; and
generate a DITA file by associating each instance of the keyword with a step for a DITA task.

18. The system of claim 17, wherein the graphic comprises an image of screenshot.

19. The system of claim 17, wherein the wireframe file is a single page PDF document.

20. The system of claim 17, further comprising the processor executing to format the text file before identifying the plurality of instances, wherein formatting the text file comprises removing a plurality of characters from the text.
